(19) United States
(12) Patent Application Publication
(10) Pub. No.: US 2025/0299940 A1
(43) Pub. Date: Sep. 25, 2025

(54) METHOD FOR STRUCTURAL ANALYSIS OF SAMPLE MOLECULE

(71) Applicant: SHIMADZU CORPORATION, Kyoto-shi (JP)

(72) Inventors: Yuko FUKUYAMA, Kyoto-shi (JP); Hideharu SHICHI, Kyoto-shi (JP)

(21) Appl. No.: 18/870,541

(22) PCT Filed: Dec. 14, 2022
(86) PCT No.: PCT/JP2022/046104

§ 371 Date: Nov. 29, 2024

(30) Foreign Application Priority Data
May 31, 2022 (JP) 2022-089237

(51) Int. Cl. H01J 49/00; H01J 49/16

(52) U.S. Cl. CPC H01J 49/0036; H01J 49/164

(57) ABSTRACT

A method for a structural analysis of a sample molecule using a mass spectrometer includes: a process for obtaining a standard analysis condition for each of setting items for performing a molecular-related ion measurement, where the setting items include an ion amount setting item, a mass-to-charge-ratio range setting item, and a signal intensity setting item; a process for performing a product ion measurement under an altered analysis condition, to acquire mass spectrum data of the product ion measurement, where the altered analysis condition is prepared by changing at least one of analysis conditions of the ion amount setting item, the mass-to-charge-ratio range setting item and the signal intensity setting item in the standard analysis condition; a process for extracting peaks corresponding to the fragment ions; and a process for determining at least a portion of the structure of the sample molecule based on mass information of the extracted peaks.

### INCORPORATION BY REFERENCE STATEMENT

This application contains a sequence listing (filename=SHM-1084_replacement_sequence_listing.xml; size=12,679 bytes; date of creation=May 16, 2025) which is herein incorporated by reference in its entirety.

### TECHNICAL FIELD

The present invention relates to a method for a structural analysis of a sample molecule using mass spectrometry.

### BACKGROUND ART

In a mass spectrometer having an ion source employing a matrix-assisted laser desorption/ionization (MALDI) method (MALDI-MS), a sample for analysis prepared by mixing a sample and an ionization assistant reagent which is called matrix is irradiated with laser light for a short period of time to ionize sample molecules in the sample for analysis, and the generated ions are introduced into a mass separator to separate and detect the ions according to their mass-to-charge ratios (m/z).

The MALDI method is generally known as a soft ionization method which can ionize refractory compounds without significantly breaking them. Therefore, MALDI-MSs have been widely used for obtaining molecular-weight information of biomacromolecules, such as nucleic acids, nucleic-acid-related substances, peptides, proteins and sugar chains. In a structural analysis of this type of biomacromolecule, a molecular-related ion (precursor ion) generated from a sample molecule in the MALDI ion source is intentionally dissociated by an appropriate method, and the various fragment ions thereby generated are subjected to a mass spectrometric analysis to estimate the structure of the sample molecule based on the mass information of those fragment ions.

For example, in a method for a structural analysis of a nucleic acid described in Non Patent Literatures 1-3, a mass spectrometric analysis of various fragment ions (ISD fragments) of a nucleic acid generated by in-source decay (ISD) is performed by means of a MALDI-TOFMS, and the base sequence information of the nucleic acid is analyzed based on the mass information of the fragment ions obtained by the analysis. In-source decay is a technique in which ions are dissociated within the ion source simultaneously with or immediately after the ionization. As noted earlier, MALDI is a soft ionization method, so that dissociation of an ion is basically difficult to occur. However, it has been known that dissociation of an ion can be promoted in the ionization process, for example, by increasing the strength of the laser light to increase the energy for the ionization, or by using a special matrix. As regards the ISD of nucleic acid molecules, it has been known that the thereby generated ISD fragments include a, b, c, d/w, x, y and z-ions as well as other ions resulting from the molecule being specifically broken at one of the phosphodiester linkage sites (or phosphorothioate linkage sites, or the like).

### CITATION LIST

### Non Patent Literature

Non Patent Literature 1: Nathan A. Hagan and five other authors, “Enhanced In-Source Fragmentation in MALDI-TOF-MS of Oligonucleotides Using 1,5-Diaminonapthalene”, Journal of the American Society for Mass Spectrometry, (USA), 2012, 23, pp. 773-777
Non Patent Literature 2: Hisao Shimizu and six other authors, “Application of high-resolution ESI and MALDI mass spectrometry to metabolite profiling of small interfering RNA duplex”, Journal of Mass Spectrometry, (USA), 2012, 47, pp. 1015-1022
Non Patent Literature 3: Satoshi Kimura and another author, “Effect of oligonucleotide structural difference on matrix-assisted laser desorption/ionization in-source decay in comparison with collision-induced dissociation fragmentation”, (USA), Rapid Communications in Mass Spectrometry, 2020, 34, e8819
Non Patent Literature 4: Scott A. McLuckey and two other authors, “Tandem mass spectrometry of small, multiply charged oligonucleotides”, Journal of the American Society for Mass Spectrometry, (USA), 1992, 3, pp. 60-70

### SUMMARY OF INVENTION

### Technical Problem

In the method described in Non Patent Literatures 1-3, a MALDI-TOFMS is used as the mass spectrometer, in which a large number of kinds of ions generated within the ion source are introduced into the mass separation unit, in which each kind of ion is separately detected in ascending order of their mass. Therefore, when ISD is performed, fragment ions are detected over a wide range from low-mass to high-mass regions. In this case, there is the problem that the peaks of the fragment ions in the low-mass region overlap with those of the cluster ions (or the like) originating from the matrix, or that their detection is suppressed due to the ion suppression effect (or the like). Additionally, since the detection of ions within the low-mass region is prioritized in the MALDI-TOFMS, there may be the case where it is difficult to achieve a sufficient level of sensitivity for high-mass fragment ions. Another problem is that, since the target mass range of a single measurement is wide, the detection sensitivity and the resolution of the entire group of fragment ions tend to be low, particularly under a condition in which the efficiency of the fragmentation from the precursor ion is low.

There is still another problem that the resolution may become low due to the overlap of the peak of a fragment ion near the m/z value of the precursor ion with that of a non-fragment ion (e.g., a base elimination peak in the case of a nucleic acid), or due to the generation of fragment ions that cannot be satisfactorily resolved since an excessive amount of energy is imparted to the precursor ion in the fragmentation process.

For example, an ISD spectrum of a nucleic acid obtained by a MALDI-TOFMS is shown in FIG. 5 of Non Patent Literature 2. In this ISD spectrum of FIG. 5, the peak of a fragment ion near the m/z value of a precursor ion dissociated at a base-sequence portion near the 3′-terminal or 5′-terminal overlaps with that of a non-fragment ion, and furthermore, the sensitivity and resolution of that peak is lower than those of the peak of a fragment ion dissociated at a base-sequence portion distant from the 3′-terminal or 5′-terminal (the peak of a fragment ion detected at a m/z value distant from around the m/z value of the precursor ion toward the low-mass region).

The present invention has been developed to solve the previously described problem, aiming to provide a method for a structural analysis in which fragment ions necessary for a structural analysis of a sample molecule can be detected with a high sensitivity over a comparatively wide mass range from low-mass to high-mass regions.

### Solution to Problem

A method for a structural analysis of a sample molecule according to the present invention developed for solving the previously described problem is a method for analyzing the structure of a sample molecule using an ion trap mass spectrometer including: an ion source employing a matrix-assisted laser desorption/ionization (MALDI) method; an ion-capturing section for separating, from ions generated in the ion source, an ion having a predetermined mass-to-charge ratio and capturing the same ion; and a detecting section for detecting an ion captured by the ion-capturing section, and the method including:
a standard analysis condition acquisition process for obtaining a standard analysis condition for each of setting items for performing a molecular-related ion measurement for detecting a molecular-related ion of the sample molecule contained in a sample by means of the mass spectrometer, where the setting items include an ion amount setting item concerning the amount of ions to be generated in the ion source, a mass-to-charge-ratio range setting item concerning the mass-to-charge-ratio range of ions to be captured in the ion-capturing section, and a signal intensity setting item concerning the signal intensity of an ion in the detecting section;
a product ion measurement data acquisition process for performing a product ion measurement for detecting a plurality kinds of first fragment ions resulting from dissociation of the molecular-related ion, under an altered analysis condition, to acquire mass spectrum data of the product ion measurement, where the altered analysis condition is prepared by changing at least one of the analysis conditions of the ion amount setting item, the mass-to-charge-ratio range setting item and the signal intensity setting item in the standard analysis condition obtained in the standard analysis condition acquisition process;
a first fragment peak extraction process for extracting peaks corresponding to the plurality kinds of first fragment ions from the mass spectrum data acquired in the product ion measurement data acquisition process; and
a data analysis process for determining at least a portion of the structure of the sample molecule based on mass information of the peaks extracted in the first fragment peak extraction process.

Another mode of the present invention developed for solving the previously described problem is a method for analyzing the structure of a sample molecule using an ion trap mass spectrometer including: an ion source employing a matrix-assisted laser desorption/ionization (MALDI) method; an ion-capturing section for separating, from ions generated in the ion source, an ion having a predetermined mass-to-charge ratio and capturing the same ion; and a detecting section for detecting an ion captured by the ion-capturing section, and the method including:
a standard analysis condition acquisition process for obtaining a standard analysis condition for each of setting items for performing a molecular-related ion measurement for detecting a molecular-related ion of the sample molecule contained in a sample by means of the mass spectrometer, where the setting items include an ion amount setting item concerning the amount of ions to be generated in the ion source, a mass-to-charge-ratio range setting item concerning the mass-to-charge-ratio range of ions to be captured in the ion-capturing section, and a signal intensity setting item concerning the signal intensity of an ion in the detecting section;
a product ion measurement process for performing a product ion measurement for detecting a plurality kinds of first fragment ions resulting from dissociation of the molecular-related ion, under an altered analysis condition prepared by changing at least one of the analysis conditions of the ion amount setting item, the mass-to-charge-ratio range setting item and the signal intensity setting item in the standard analysis condition obtained in the standard analysis condition acquisition process;
an MS/MS measurement condition setting process for setting a measurement condition for performing an MS/MS measurement in which at least one of the plurality kinds of first fragment ions detected in the product ion measurement is used as a precursor ion;
an MS/MS measurement data acquisition process for acquiring mass spectrum data of the MS/MS measurement by performing the MS/MS measurement based on the measurement condition set in the MS/MS measurement condition setting process;
a second fragment peak extraction process for extracting, from the mass spectrum data acquired in the MS/MS measurement data acquisition process, a peak corresponding to a second fragment ion generated in the MS/MS measurement; and
a data analysis process for determining a portion of the structure of the sample molecule based on mass information of the peak extracted in the second fragment peak extraction process.

In the present invention, the term “molecular-related ion” generally refers to any ion that directly serves for the acquisition of molecular-weight information. It specifically includes, for example, a protonated molecule, deprotonated molecule and sodium adduct molecule.

### Advantageous Effects of Invention

According to the present invention, fragment ions necessary for a structural analysis of a sample molecule can be detected with a high sensitivity over a comparatively wide mass range from low-mass to high-mass regions. Consequently, a sufficient number of fragment ions for performing a structural analysis of a sample molecule can be detected. In particular, a larger amount of structural information, such as sequence information, can be determined for a molecular structure of a sample molecule including a comparatively high-mass molecule, such as a biomacromolecule.

According to another mode of the present invention, a fragment ion (second fragment ion) generated by further dissociating a fragment ion (first fragment ion) originating from a molecular-related ion can be detected with a high sensitivity. Consequently, structural information can be more assuredly determined for a partial molecular structure of a sample molecule which cannot be accurately analyzed based only on the mass information of the first fragment ions.

### BRIEF DESCRIPTION OF DRAWINGS

FIG. 1 A schematic configuration diagram showing one example of a mass spectrometer to be used for carrying out a method for a structural analysis according to the present invention.

FIG. 2 A flowchart showing the procedure of a method for a structural analysis according to one embodiment of the present invention.

FIG. 3 A flowchart showing the procedure of a method for a structural analysis according to another embodiment of the present invention.

FIG. 4 A diagram showing mass spectra of standard nucleic acid A in the case of using conditions (a) through (e) in Example 1.

FIG. 5 A diagram showing a mass spectrum of standard nucleic acid A and the state of sequence analysis of standard nucleic acid A in the case of using condition (e) in Example 1.

FIG. 6 A diagram showing mass spectra of standard nucleic acid A in the case of using conditions (b) through (d) in Example 2.

FIG. 7 A diagram showing a mass spectrum of standard nucleic acid A and the state of sequence analysis of standard nucleic acid A in the case of using condition (d) in Example 2.

FIG. 8A A diagram showing mass spectra (m/z 2000-6000) of standard nucleic acid A in the case of using conditions (b) and (c) in Example 3.

FIG. 8B A diagram showing mass spectra (m/z 3000-5000) of standard nucleic acid A in the case of using conditions (b) and (c) in Example 3.

FIG. 9 A diagram showing a mass spectrum of standard nucleic acid A and the state of sequence analysis of standard nucleic acid A in the case of using condition (c) in Example 3.

FIG. 10 A diagram showing mass spectra of standard nucleic acid A and the state of sequence analysis of standard nucleic acid A in the case of using conditions (b) and (c) in Example 3.

FIG. 11 A diagram showing mass spectra of mipomersen and the state of sequence analysis of mipomersen in the case of using conditions (a) and (b) in Example 4.

FIG. 12 A diagram showing a mass spectrum of mipomersen and the state of sequence analysis of mipomersen in the case of using a measurement condition for an MS/MS measurement in Example 4.

### DESCRIPTION OF EMBODIMENTS

To address the previously described problem, the present inventors have attempted to perform a structural analysis of a sample molecule with an ion trap (IT) mass spectrometer having a MALDI ion source (MALDI-ITMS), using a matrix for ISD which has been proved to be capable of promoting dissociation of ions. It should be noted that there has so far been virtually no report on an attempt of ISD using a MALDI-ITMS. The result demonstrated that, although the dissociation of an ion occurs, the fragment ions thereby obtained are limited to those located near the m/z value of the precursor ion. A possible cause of this is that there is a difference in the condition for capturing ions by the space-charge effect of the MALDI-ITMS between the precursor ion and the fragment ions at lower mass-to-charge ratios at which the dissociation of the precursor ion more abundantly occurs. This phenomenon was particularly noticeable in the case where the analysis target was a high-mass molecule.

In a method for a structural analysis of a sample molecule using a MALDI-ITMS, the present invention aims to provide a method by which fragment ions within a low-mass region can be particularly detected with a high sensitivity and in a prioritized manner from among the fragment ions necessary for a data analysis.

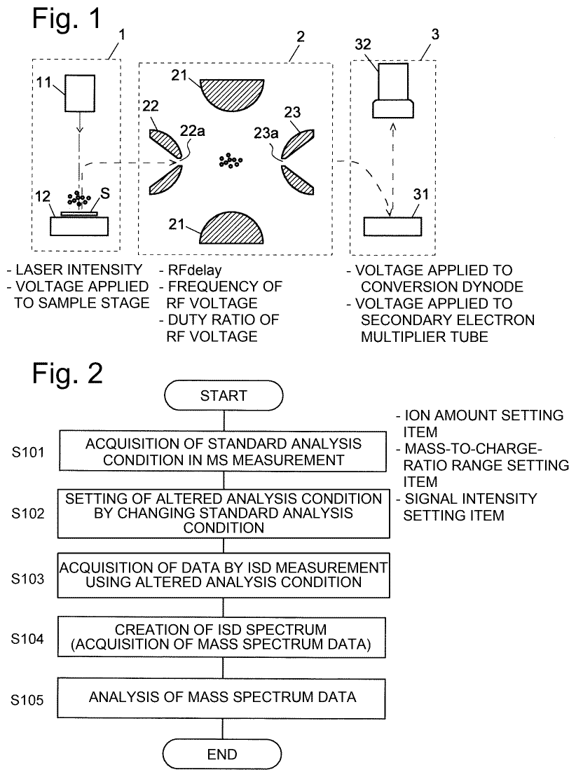

Hereinafter, one embodiment of the method for a structural analysis of a sample molecule according to the present invention is described with reference to the drawings. FIG. 1 is a schematic configuration diagram showing one example of a mass spectrometer to be used for carrying out the method for a structural analysis according to the present embodiment.

### <Mass Spectrometer>

The mass spectrometer used in the present embodiment is an ion trap mass spectrometer, which includes: an ion source 1 configured to ionize a sample containing an analysis target; an ion trap 2 (which corresponds to the ion-capturing section in the present invention) configured to temporarily capture ions of predetermined mass-to-charge ratios among the ions generated in the ion source 1, by the effect of a radiofrequency electric field, and to separate the captured ions according to their mass-to-charge ratios (m/z); and a detecting section 3 configured to detect the separated ions.

The ion source 1, which is an ion source employing a MALDI method, includes a laser irradiator 11 configured to irradiate a sample with laser light and a sample stage 12 on which a sample plate S, with a sample placed thereon, is to be placed. The ion trap 2 is a quadrupole ion trap including an annular ring electrode 21 as well as a pair of end-cap electrodes 22 and 23 arranged to face each other across the ring electrode 21. An ion injection hole 22a is formed in the entrance end-cap electrode 22, while an ion ejection hole 23a is formed in the exit end-cap electrode 23. The detecting section 3 includes a conversion dynode 31 configured to convert ions into electrons as well as a detector (secondary electron multiplier tube) 32 configured to multiply and detect electrons coming from the conversion dynode 31.

To the ring electrode 21 and the end-cap electrodes 22 and 23, predetermined voltages are respectively applied. By means of the thereby created radiofrequency electric field, ions can be captured within an inner space surrounded by the ring electrode 21 and the end-cap electrodes 22 and 23, or ions can be ejected from the inner space to the outside through the ion ejection hole 23a.

The range of the mass-to-charge ratios of the ions to be captured within the ion trap in a prioritized manner is controlled by changing the period of time from the irradiation of the sample with the laser light in the ion source 1 to the application of a capturing voltage for capturing ions to the ring electrode 21 of the ion trap 2 (this period of time is hereinafter called the delay time). Setting a longer delay time allows high-mass ions to be more assuredly captured than the other ions, while setting a shorter delay time allows low-mass ions to be more assuredly captured.

The predetermined voltages applied to the ring electrodes 21 and the end-cap electrodes 22 and 23 may be sinusoidal radiofrequency voltages, or rectangular voltages generated by a high-speed switching operation between two different voltages. In the case of a digital ion trap which uses an electric field generated by a rectangular voltage, the range of the mass-to-charge ratios of the ions that can be captured is controlled by varying the frequency of the rectangular voltage while constantly maintaining its amplitude (voltage value), or by varying the duty ratio which is the ratio between the switching intervals of the rectangular voltage.

The ion trap mass spectrometer according to the present embodiment includes a mass spectrometer in which the mass-separating function of the ion trap itself is used to eject the captured ions from the ion trap in ascending order of mass-to-charge ratio, and those ions are detected with a detector located outside the ion trap. It also includes a mass spectrometer in which ions simultaneously ejected from the ion trap are separated from each other according to their mass-to-charge ratios by a mass separation unit, such as a time-of-flight mass separation unit, located outside the ion trap and are detected with a detector which is also located outside the ion trap. It may also be a tandem type of mass spectrometer having a configuration in which two mass separation units are serially connected so as to enable an MS/MS measurement which will be described later.

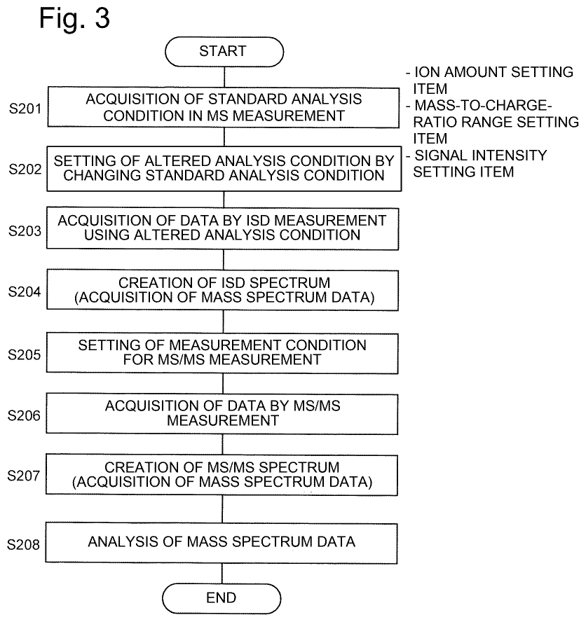

Next, the procedure of the method for a structural analysis according to the present embodiment is described with reference to the flowchart of FIG. 2.

### <Method for Structural Analysis>

Hereinafter described is an example in which an ion trap mass spectrometer having a digital ion trap is used as the mass spectrometer.

[Step 101: Acquisition of Standard Analysis Condition for Performing MS Measurement]

Initially, a standard analysis condition for performing a measurement for detecting a molecular-related ion (e.g., protonated molecule [M+H]⁺ or deprotonated molecule [M−H]⁻) of a sample molecule which is the analysis target is acquired (this measurement corresponds to the molecular-related ion measurement in the present invention and is hereinafter called the MS measurement). The MS measurement is a measurement which involves no dissociation of ions (or only an insignificant amount of ions undergo dissociation) since it uses a measurement condition for detecting the molecular-related ion with the highest possible sensitivity and resolution. Mass spectrometers have various setting items which can be appropriately set according to the kind of analysis target, purpose of the analysis and other factors. In the method for a structural analysis according to the present embodiment, a standard analysis condition is obtained for each of the following items: an ion amount setting item concerning the amount of ions to be generated in the ion source 1, a mass-to-charge-ratio range setting item concerning the mass-to-charge-ratio range of the ions to be captured within the ion trap 2, and a signal intensity setting item concerning the signal intensity of an ion in the detecting section 3.

A standard analysis condition is a representative one of the conditions under which a molecular-related ion of a sample molecule can be detected. As an example of the method for acquiring a standard analysis condition, if the molecular-related ion of the sample molecule could be detected as a result of an MS measurement using default values of various setting items previously set in a mass spectrometer, those default values may be used as a standard analysis condition. In that case, retrieving the default values from a storage section or similar location at which those default values are stored corresponds to the acquisition of the standard analysis condition. Alternatively, an MS measurement may be performed in which the setting values of the various setting items are changed from their respective default values so that the molecular-related ion of the sample molecule will be detected with higher levels of sensitivity and resolution, to locate values with which the molecular-related ion of the sample molecule can be detected (e.g., threshold values).

The ion amount setting item may be the laser strength (laser power) for irradiation in the laser irradiator 11. The mass-to-charge-ratio range setting item may be an RFdelay value corresponding to the delay time. The signal intensity setting item may be a voltage applied to the conversion dynode 31 or a voltage applied to the detector (secondary electron multiplier tube) 32.

### [Step 102: Setting of Altered Analysis Condition by Changing Standard Analysis Condition]

Next, an altered analysis condition is set by changing at least one of the setting items, i.e., the ion amount setting item, mass-to-charge-ratio range setting item and signal intensity setting item in the standard analysis condition acquired in Step 101. In other words, it is possible that the ion amount setting item, mass-to-charge-ratio range setting item or signal intensity setting item is solely changed, with the other setting items unchanged. In that case, as compared to the case where the MS measurement is performed under the standard analysis condition, the ion amount setting item should be changed so that the amount of ions generated in the ion source 1 will increase, or the mass-to-charge-ratio range setting item should be changed so that low-mass ions will be captured in a prioritized manner within the ion trap 2, or the signal intensity setting item should be changed so that the signal intensity of an ion will be higher in the detecting section 3.

Specifically, in the case of changing the intensity of the laser light, which is an ion amount setting item, the value should preferably be set to be higher than the standard analysis condition; more preferably, for example, the value should be set to be 1-40% higher than the value in the standard analysis condition, and even more preferably, 1-30% higher. In the case of changing the RFdelay value, which is a mass-to-charge-ratio range setting item, the value should preferably be set to be lower than the standard analysis condition; more preferably, for example, the value should be set to be 5-30% lower than the value in the standard analysis condition, and even more preferably, 10-20% lower (so that the delay time will be 1-3 microseconds). In the case of changing the application voltage to the conversion dynode 31, which is a signal intensity setting item, the value should preferably be set to be higher than the standard analysis condition; for example, the value should preferably be set to be 5-30% higher, and even more preferably, 10-30% higher. In the case of changing the application voltage to the detector (secondary electron multiplier tube) 32, which is also a signal intensity setting item, the value should preferably be set to be higher than the standard analysis condition; for example, the value should preferably be set to be 5-50% higher, and even more preferably, 10-50% higher.

### [Step 103: Acquisition of Data by ISD Measurement Using Altered Analysis Condition]

Using the altered analysis condition, a measurement for detecting fragment ions resulting from dissociation of the molecular-related ion of the sample molecule (precursor ion) is performed (this measurement corresponds to the product ion measurement in the present invention), and data related to the detected ions is acquired. In the present invention, the generation mechanism of the fragment ions originating from the sample molecule is not yet revealed. Therefore, in the present description, the dissociation which occurs simultaneously with or immediately after the ionization within the ion source of the MALDI ion trap mass spectrometer as well as other types of dissociation of ions which occurs in the subsequent stages in the device are generally called the in-source decay (ISD), and the aforementioned measurement which involves ISD (product ion measurement) is called the ISD measurement. Furthermore, the fragment ions generated in the aforementioned measurement are called the first fragment ions or ISD fragments. By the ISD measurement using the altered analysis condition, the first fragment ions within a low-mass region distant from the m/z value of the molecular-related ion can be particularly detected with a high sensitivity.

In Step 103, it is possible to additionally perform an ISD measurement using a condition in which the range of the predetermined mass-to-charge ratios of the ions to be captured by the ion trap 2 is set so that the largest value of those predetermined mass-to-charge ratios becomes smaller than the value of the mass-to-charge ratio of the molecular-related ion of the sample molecule. In that case, for example, the largest value of the predetermined mass-to-charge ratios of the ions to be captured within the ion trap 2 should be preferably set to be 0.5-40% smaller than the value of the mass-to-charge ratio of the molecular-related ion of the sample molecule, and more preferably, 0.5-20% smaller.

As regards the method for changing the range of the predetermined mass-to-charge ratios, for example, when the analysis target has a molecular weight of approximately 6000, the measurement mode may be changed to a mode which does not include the molecular weight of 6000, by switching from a measurement mode with a target mass range of m/z 2000-18000 to a measurement mode with a target mass range of m/z 650-5000 among the measurement modes previously built in the device. The target mass range of the measurement mode is determined according to the frequency of the radiofrequency voltage applied to the ion trap 2. Specifically, since the amount of ions to be captured within the ion trap is limited, the mass range to be measured is mainly determined by setting a low mass cut-off (LMCO) through the tuning of the frequency of the radiofrequency voltage. Increasing the frequency of the radiofrequency voltage decreases the setting of the LMCO, causing the target mass range of the measurement to be set within a lower-mass region. Conversely, decreasing the frequency of the radiofrequency voltage increases the setting of the LMCO, causing the target mass range of the measurement to be set within a higher-mass region. In summary, the range of the predetermined mass-to-charge ratios is changed by varying the frequency of the radiofrequency voltage applied to the ion trap 2.

As another method for changing the range of the predetermined mass-to-charge ratios, when the analysis target has a molecular weight of approximately 6000, the value of the setting item of the duty ratio, which is the ratio between the switching intervals of the rectangular voltage previously built in the device, may be changed, specifically, for example, from a standard value of 50:50 to a value of 52:48 so as to exclude ions with m/z values equal to or larger than 5500. This enables the acquisition of mass spectrum data from which first fragment ions having mass-to-charge ratios close to the m/z value of the precursor ion have been excluded. Consequently, the detection sensitivity for the first fragment ions within a low-mass region distant from the m/z value of the precursor ion will be improved.

In Step S103, the ISD measurement may be performed in both the case where the condition in which the range of the predetermined mass-to-charge ratios is set in the previously described manner is used, and the case where that condition is not used, to acquire mass spectrum data obtained by each measurement. This enables the detection of the first fragment ions originating from the sample molecule over a range from low-mass to high-mass regions.

Furthermore, in the case of using the condition in which the range of the predetermined mass-to-charge ratios of the ions to be captured by the ion trap 2 is set so that the largest value of the predetermined mass-to-charge ratios becomes smaller than the value of the mass-to-charge ratio of the molecular-related ion of the analysis target, it is possible to additionally acquire a standard analysis condition of an application voltage to the sample stage 12 in the ion source 1 in Step 102 and perform the ISD measurement using a condition in which the application voltage to the sample stage 12 is changed to a larger value than that analysis condition. The application voltage to the sample stage should be preferably set to be as high as 4-8 times the standard analysis condition, and more preferably, as high as 4-5 times.

### [Step 104: Creation of ISD Spectrum]

Based on the data acquired by the ISD measurement in Step 103, a mass spectrum (ISD spectrum) is created. The mass spectrum data in the present invention includes information concerning the mass-to-charge ratio and the signal intensity of each peak in the mass spectrum, and the mass spectrum data of the ISD measurement (ISD spectrum data) is acquired in Step 104.

### [Step 105: Analysis of Mass Spectrum Data]

From the ISD spectrum data acquired in Step 104, the peaks corresponding to the various first fragment ions are extracted, the assignment of the various first fragment ions is determined based on the mass information shown by those peaks, and, by combining the thereby obtained results, at least a portion of the structure of the original sample molecule is determined. The determination of the structure includes a sequencing analysis as well as the process of identifying the type of chemical modification or locating a chemically modified site by the sequencing analysis. A database search or de novo sequencing may be used for the determination of the structure.

In the case where the ISD measurement in Step 103 was performed in both the case where the condition in which the range of the predetermined mass-to-charge ratios is set is used and the case where that condition is not used, and mass spectrum data was acquired from both ISD measurements in Step 104, the results of the assignment of the various first fragment ions obtained from both measurements may be combined for the data analysis. This enables a more assured structural analysis of the analysis target.

### <Analysis Target>

The analysis target in the present invention is, for example, a sample molecule containing a comparatively high-mass molecule, such as a biomacromolecule. Examples of the biomacromolecule include nucleic acids, peptides, sugar chains, proteins and lipids.

The nucleic acids in the present context include nucleic-acid-related substances, such as modified nucleic acids, nucleic acid derivatives or oligonucleotide therapeutics. In the following descriptions, nucleic acids and nucleic-acid-related substances are collectively and simply referred to as nucleic acids. When the analysis target is a nucleic acid, there is no specific limitation on the degree of polymerization (base length), although oligonucleotides with several to tens of nucleotides polymerized are preferable. Since the analysis method according to the present invention particularly improves the analysis sensitivity for high-molecular nucleic acids, the nucleic acid may preferably have a molecular weight equal to or larger than 3000, and particularly, equal to or larger than 6000. The nucleic acid may be a natural substance obtained from a living organism or a processed product of that substance, or alternatively, it may be an artificial synthetic nucleic acid which has been chemically synthesized.

### <Method for Preparing Sample for Analysis>

As one example, it is hereinafter assumed that the analysis target is a nucleic acid. The sample for analysis is prepared by drying a mixed solution, which is a mixture of a nucleic-acid-containing sample and a matrix substance, dropped onto a sample plate. For this task, a mixed solution prepared beforehand may be dropped onto and dried on the sample plate, or alternatively, the mixed solution may be prepared on the sample plate and then dried on the same plate.

As regards the matrix substance, an appropriate substance according to the kind of nucleic acid can be selected. Examples include 3-hydroxypicolinic acid (3-HPA), 2,4-dihydroxyacetophenone (2,4-DHAP), 2,5-dihydroxybenzoic acid (DHB), 2′,4′,6′-trihydroxyacetophenone monohydrate (THAP), 6-aza-2-thiothymine (ATT), 3-aminopyrazine-2-carboxylic acid (APCA), anthranilic acid (AA) and nicotinic acid (NA). Among them, 2,4-DHAP and THAP are preferable. A mixed matrix consisting of a mixture of two or more matrix substances may also be used, among which a mixed matrix prepared by mixing 3-HPA and 2,4-DHAP, or 3-HPA and THAP, or 2,4-DHAP and THAP is preferable.

The sample for analysis may further contain a matrix additive. Ammonium citrate dibasic (ACD) can be used as the matrix additive. There are several kinds of ammonium salts of citric acid depending on the number of ammonium ions binding to a citrate ion, of which a salt with two ammonium ions binding to one citrate ion is preferable for use in the present embodiment.

In the case where a matrix additive is contained in the sample for analysis, there is no specific limitation on the order in which the nucleic-acid-containing sample, the matrix substance and the matrix additive are mixed, although it is preferable to previously prepare a matrix-and-additive mixed solution containing the matrix substance and the matrix additive, and then prepare the sample for analysis by mixing a sample solution containing the nucleic acid with this matrix-and-additive mixed solution. In this case, a mixed solution consisting of the sample solution and the matrix-and-additive mixed solution mixed beforehand may be dropped onto and dried on a sample plate to prepare the sample for analysis, or alternatively, the sample solution and the matrix-and-additive mixed solution may be individually dropped onto a sample plate, then mixed with each other and dried on the sample plate to prepare the sample for analysis. Preparing the matrix-and-additive mixed solution beforehand facilitates the preparation of the sample for analysis. The concentration of the matrix additive in the matrix-and-additive mixed solution should preferably be 10-100 mM, and more preferably 30-70 mM, from the viewpoint that the molecular-related ion of the nucleic acid should be produced in a sufficient quantity.

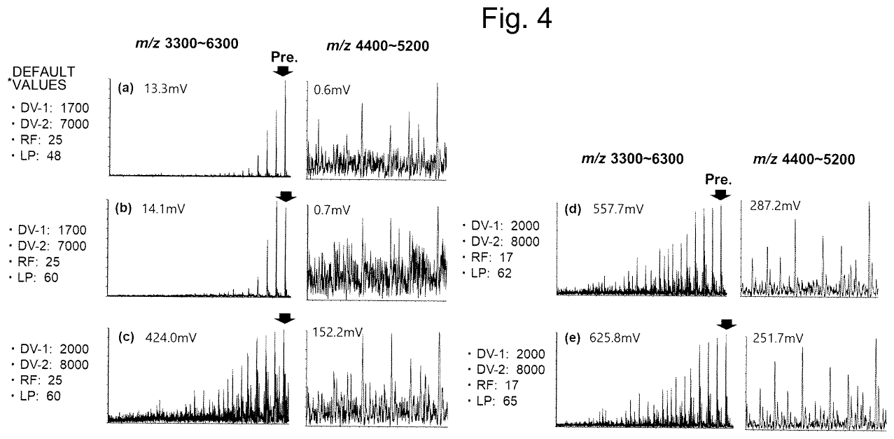

Next, another embodiment of the method for a structural analysis of a sample molecule according to the present invention is described with reference to the drawings. FIG. 3 is a flowchart showing the procedure of the method for a structural analysis according to the present embodiment.

### [Step 201: Acquisition of Standard Analysis Condition for Performing MS Measurement]

### [Step 202: Setting of Altered Analysis Condition by Changing Standard Analysis Condition]

### [Step 203: Acquisition of Data by ISD Measurement Using Altered Analysis Condition]

### [Step 204: Creation of ISD Spectrum]

By a similar method to the previously described Steps 101-104, a standard analysis condition for performing an MS measurement is acquired (Step 201), an altered condition is set by changing the standard analysis condition (Step 202), data is acquired by an ISD measurement using the altered condition (Step 203), an ISD spectrum is created based on that data, and ISD spectrum data is acquired (Step 204).

### [Step 205: Setting of Measurement Condition for MS/MS Measurement]

Based on the ISD spectrum data acquired in Step 204, at least one of the first fragment ions detected in the ISD measurement of Step 203 is selected as a precursor ion, and a measurement condition for performing an MS/MS measurement for the precursor ion is set. An MS/MS measurement is generally known as a measurement technique which includes: selecting, in a front mass separation unit, an ion having a specific mass-to-charge ratio as a precursor ion from among the ions generated from a sample molecule; dissociating the precursor ion by collision induced dissociation (CID) within a collision cell in the subsequent stage to generate various fragment ions (product ions); and separating the fragment ions (product ions) from each other in a rear mass separation unit. In the MS/MS measurement in the ion trap mass spectrometer used in the present embodiment, only ions falling within a specific mass range (having specific mass-to-charge ratios) are retained within the ion trap 2 to select these ions as precursor ions. Those precursor ions are subsequently dissociated by CID with argon or similar gas introduced into the ion trap 2 to generate product ions including various fragment ions, and a mass scan is subsequently performed to eject those ions in ascending order of their mass-to-charge ratios.

As regards the precursor ion, it is preferable to select a first fragment ion which has been detected with a comparatively high level of sensitivity and the least possible overlap with other peaks in the ISD spectrum data acquired in Step 204. Selecting such a first fragment ion as the precursor ion enables high-sensitivity detection of a plurality of fragment ions generated in the subsequent MS/MS measurement (the fragment ions generated in the MS/MS measurement may hereinafter be called the second fragment ions). It is preferable to select, as the precursor ion, a first fragment ion located within a low-mass region distant from the m/z value of the molecular-related ion. Selecting such a first fragment ion prevents the mass spectrum obtained by the MS/MS measurement from being complex, so that the data analysis will be easier. The m/z value of the first fragment to be selected as the precursor ion should preferably be equal to or lower than m/z 5000, more preferably equal to or lower than m/z 3000, and even more preferably equal to or lower than m/z 2000.

### [Step 206: Acquisition of Data by MS/MS Measurement]

An MS/MS measurement is performed based on the measurement condition set in Step 205, and data related to the detected peaks is acquired.

### [Step 207: Creation of MS/MS Spectrum]

A mass spectrum (MS/MS spectrum) is created based on the data acquired in Step 206, and mass spectrum data of the MS/MS measurement (MS/MS spectrum data) is acquired.

### [Step 208: Analysis of Mass Spectrum Data]

Similar to Step 105, the peaks corresponding to the various first fragment ions are extracted from the ISD spectrum data acquired in Step 204, the assignment of the various first fragment ions is determined based on the mass information shown by those peaks, and, by combining the thereby obtained results, at least a portion of the structure of the original sample molecule is determined. Furthermore, the peaks corresponding to the various second fragment ions are extracted from the MS/MS spectrum data acquired in Step 207, the assignment of the various second fragment ions is determined based on the mass information shown by those peaks, and, by combining the thereby obtained results, a portion of the structure of the original sample molecule is determined. By combining the peak assignment result of the ISD measurement and that of the MS/MS measurement, a larger amount of information concerning the structure of the sample molecule can be obtained, so that the accuracy of the structural analysis will be improved. From the peak assignment result of the MS/MS measurement, it is easier to obtain information on the terminal structure of the sample molecule; this structural information cannot be easily obtained from only the ISD measurement since its sensitivity for ISD fragments tends to be low. In particular, when the sample molecule is a nucleic acid, the structure near the 3′-terminal or 5′-terminal of the nucleic acid (e.g., base sequence or modification information) can be determined from the peak assignment result of the MS/MS measurement.

In the present embodiment, the assignment of the first fragment ions and that of the second fragment ions are determined in Step 208, based on the ISD spectrum data acquired in Step 204 and the MS/MS spectrum data acquired in Step 207, respectively. It is also possible to only determine the assignment of the second fragment ions based on the MS/MS spectrum data acquired in Step 207. In that case, after the first fragment ions generated by the ISD measurement in Step 203 have been detected and the m/z values of those first fragment ions have been obtained, Step 204 (creation of the ISD spectrum and acquisition of ISD spectrum data) may be omitted, and only a portion of the structure of the original sample molecule is determined in Step 208 by combining the assignment results of the various second fragment ions.

Hereinafter, the method for a structural analysis according to the present invention is described by means of examples, which are merely illustrative, and the present invention should not be limited to them.

### Example 1

### <1. Preparation of Sample Solution>

A 10-pmol/μL aqueous solution of standard nucleic acid A (5′-TGTGCGTGTGTAGTGTGTCT-3′: MW 6201.1, DNA, Sequence Number 1, a product synthesized on request) was prepared as a sample solution.

### <2. Preparation of Matrix Solution>

A 40 mg/mL-50% acetonitrile (ACN)-water solution of 2,4-dihydroxyacetophenone (2,4-DHAP), containing 70 mM of diammonium hydrogen citrate (ACD) as a matrix additive, was prepared as a matrix solution.

### <3. Preparation of Sample for Analysis>

The sample solution prepared in “1.” and the matrix solution prepared in “2.” were mixed at 1:1 (v/v), and 1 μL of the obtained mixed solution was dropped onto a sample plate (stainless steel plate) and dried.

### <4. Mass Spectrometric Analysis>

For the mass spectrometric analysis, a MALDI digital ion trap mass spectrometer (MALDI-DITMS; manufactured by Shimadzu Corporation, product name: MALDImini-1) was used. The sample plate, with the sample for analysis prepared in “3.” placed thereon, was set in the MALDI-DITMS, and an MS measurement and an ISD measurement were performed in the positive mode, using the raster function.

### <4-1. MS Measurement>

The values in the following Table 1 were used as the conditions (various setting values of the mass spectrometer) for performing the MS measurement. The measurement mode indicates the range of the mass-to-charge ratios of the ions to be covered by the measurement. More specifically, it defines the range of the mass-to-charge ratios of the ions to be captured within the ion trap. This range is shown in the parentheses. The same also applies to the subsequent tables.

TABLE 1

| | Condition (a) |
|---|---|
| Measurement mode | mode 3 |
| | (m/z 2000-18000) |
| Detector voltage (DV-1) | 1700 |
| Conversion dynode voltage (DV-2) | 7000 |
| RFdelay (RF) | 25 |
| Laser power (LP) | 48 |
| Sample-stage voltage (SV) | 5 |
| Duty ratio | 50:50 |

### <4-2. ISD Measurement>

The values in the following Table 2 were used as the conditions (various setting values of the mass spectrometer) for performing the ISD measurement.

TABLE 2

| | Condition | Condition | Condition | Condition |
|---|---|---|---|---|
| | (b) | (c) | (d) | (e) |
| Measurement | mode 3 | mode 3 | mode 3 | mode 3 |
| mode | (m/z | (m/z | (m/z | (m/z |
| | 2000-18000) | 2000-18000) | 2000-18000) | 2000-18000) |
| Detector | 1700 | 2000 | 2000 | 2000 |
| voltage (DV-1) | | | | |
| Conversion | 7000 | 8000 | 8000 | 8000 |
| dynode voltage | | | | |
| (DV-2) | | | | |
| RFdelay (RF) | 25 | 25 | 17 | 17 |
| Laser power | 60 | 60 | 62 | 65 |
| (LP) | | | | |
| Sample-stage | 5 | 5 | 5 | 5 |
| voltage (SV) | | | | |
| Duty ratio | 50:50 | 50:50 | 50:50 | 50:50 |

### <5. Structural Analysis>

The base sequence of standard nucleic acid A was analyzed from the acquired mass spectrum data of the fragment ions.

### <Result>

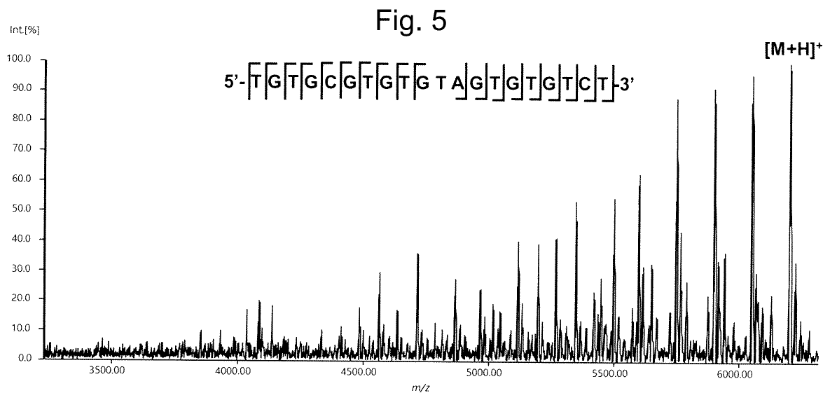

FIG. 4 shows mass spectra of standard nucleic acid A acquired by the MS measurement and the ISD measurement under each condition (i.e., mass spectra acquired using conditions (a), (b), (c), (d) and (e), from the top). Of the mass spectra under each condition, the left one shows the entire range of the mass-to-charge ratios covered by the measurement (m/z 3300-6300), while the right one is an enlarged view of a portion (m/z 4400-5200) of that range. The arrows in the drawing indicate the detection state of the molecular-related ion ([M+H]⁺, precursor ion). The numerical values in the drawing show the peak intensity (mV) of the ion having the highest intensity in each mass spectrum.

From FIG. 4, it was confirmed that the protonated molecule [M+H]⁺ of standard nucleic acid A could be detected with a high sensitivity in the mass spectrum of m/z 3300-6300 under condition (a). Simultaneously, although the peaks of some fragment ions including base elimination ions were detected under condition (a), the number of fragment ions was small, and their detection sensitivity was low ((a) in FIG. 4).

On the other hand, under the conditions (b)-(e) in which the detector voltage, conversion dynode voltage, RFdelay value and laser power were gradually changed, it was confirmed that the detection sensitivity of the fragment-ion peaks improved, and the number of detected peaks increased ((b)-(e) in FIG. 4). In particular, a comparison of the case of the measurement using condition (a) and that of the measurement using condition (e) shows that the sensitivity for the fragment-ion peaks detected at lower mass-to-charge ratios improved, and the number of detected peaks dramatically increased.

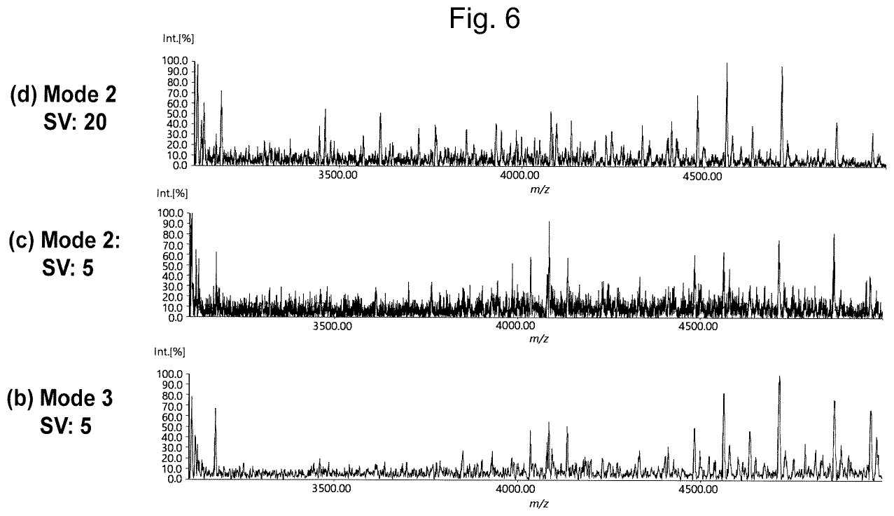

FIG. 5 shows the ISD spectrum of the fragment ions obtained under condition (e) and the state of base sequence analysis of the nucleic acid. From FIG. 5, the sequence of standard nucleic acid A could be almost entirely determined (90% of the entire sequence, exclusive of a sequence around the center).

A possible reason for the previously described results is that changing the laser power to a higher value than the value in the normal mode of MS measurement increased the amount of ions generated in the ion source, while changing the detector voltage and the conversion dynode voltage to higher values than the values in the normal mode of MS measurement amplified the individual ion signals. Furthermore, it is most likely that changing the RFdelay value to a lower value than the value in the normal mode of MS measurement enabled the prioritized capturing of the fragment ions at lower mass-to-charge ratios than the precursor ion, with the result that the detection sensitivity for the fragment ions could be improved. As described so far, it has been confirmed that an ISD analysis using a MALDI-ITMS is possible, and the sequence can be almost entirely determined for a standard nucleic acid having a comparatively high mass (MW 6201).

### Example 2

A mass spectrometric analysis and a structural analysis were performed in a similar manner to Example 1, except for a difference in the measurement conditions for the MS measurement and the ISD measurement.

### <4-1. MS Measurement>

The values in the following Table 3 were used as the conditions (various setting values of the mass spectrometer) for performing the MS measurement.

TABLE 3

| | Condition (a) |
|---|---|
| Measurement mode | mode 3 |
| | (m/z 2000-18000) |
| Detector voltage (DV-1) | 1700 |
| Conversion dynode voltage (DV-2) | 7000 |
| RFdelay (RF) | 25 |
| Laser power (LP) | 64 |
| Sample-stage voltage (SV) | 5 |
| Duty ratio | 50:50 |

### <4-2. ISD Measurement>

The values in the following Table 4 were used as the conditions (various setting values of the mass spectrometer) for performing the ISD measurement.

TABLE 4

| | Condition (b) | Condition (c) | Condition (d) |
|---|---|---|---|
| Measurement mode | mode 3 | mode 2 | mode 2 |
| | (m/z | (m/z | (m/z |
| | 2000-18000) | 650-5000) | 650-5000) |
| Detector voltage (DV-1) | 2000 | 2000 | 2000 |
| Conversion dynode | 8000 | 8000 | 8000 |
| voltage (DV-2) | | | |
| RFdelay (RF) | 17 | 17 | 17 |
| Laser power (LP) | 75 | 75 | 75 |
| Sample-stage voltage | 5 | 5 | 20 |
| (SV) | | | |
| Duty ratio | 50:50 | 50:50 | 50:50 |

### <Result>

Initially, though not shown, under condition (a), it was confirmed that the protonated molecule [M+H]⁺ of standard nucleic acid A could be detected with a high sensitivity.

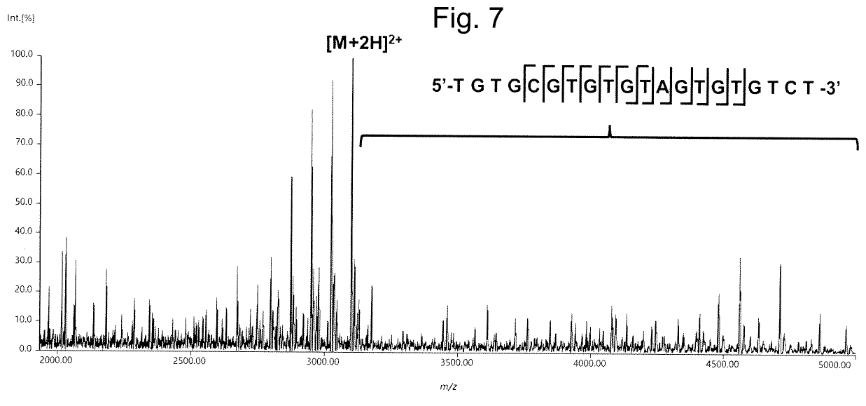

Next, FIG. 6 shows ISD spectra of standard nucleic acid A acquired by the ISD measurement under each condition (i.e., ISD spectra acquired using conditions (b), (c) and (d), from the bottom). When the measurement was performed using condition (b) in which the detector voltage, conversion dynode voltage, RFdelay value and laser power were respectively changed from those of condition (a), the fragment ions within a high-mass region near the precursor ion were easily detected ((b) in FIG. 6). On the other hand, when the measurement was performed using conditions (c) and (d) in which, in addition to the aforementioned changes, the measurement mode was also changed so that the largest value of the mass-to-charge-ratio range of the ions to be captured within the ion trap would be smaller than the mass-to-charge ratio of the precursor ion, fragment ions were also detected within a low-mass region distant from the precursor ion ((c) and (d) in FIG. 6). In particular, it was confirmed that the fragment ions within the low-mass region can be detected in a larger quantity and with a comparatively high level of sensitivity under condition (d) in which the sample-stage voltage was set to be higher than in condition (a) ((d) in FIG. 6). It should be noted that the comparative evaluation of conditions (b)-(d) was performed using identical analysis conditions except for the measurement mode and the sample-stage voltage so that their influences can be easily understood (Table 4).

FIG. 5 shows the ISD spectrum of standard nucleic acid A as well as the sequence of standard nucleic acid A and its assignment state in the case where the ISD measurement was performed under a condition in which the laser power was changed to 65 in condition (b) in Table 4 (i.e., under condition (e) in Table 2). At least according to the present experiment, under condition (b) in Table 4, there was no practical difference in the obtained ISD spectrum between the case where the laser power was 75 (condition (b) in Table 4; (b) in FIG. 6) and the case where it was 65 (condition (e) in Table 2; FIG. 5). Therefore, FIG. 5 is hereinafter used to explain the assignment state of the ISD spectrum under condition (b) in Table 4. From FIG. 5, the assignment of a large number of fragment ions could be determined, and approximately 90% of the base sequence could be determined. However, since the sensitivity for the fragment ions within the low-mass region was low, it was impossible to analyze the entire sequence.

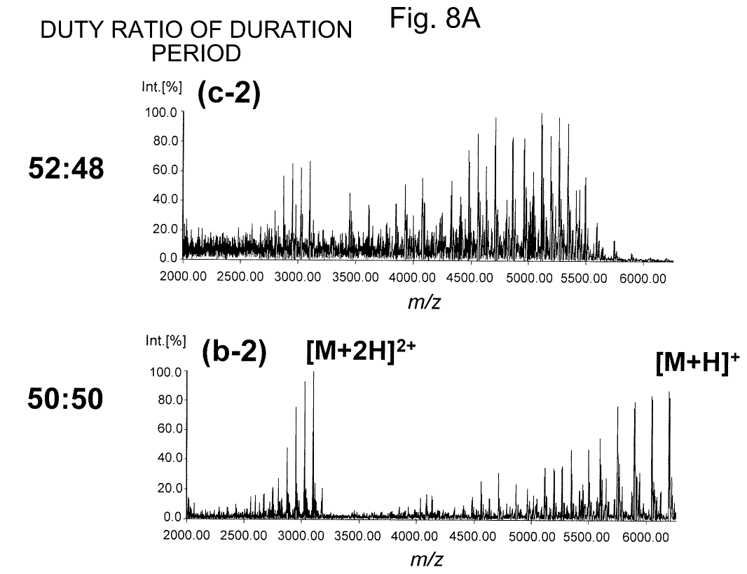

FIG. 7 shows the ISD spectrum of standard nucleic acid A as well as the sequence of standard nucleic acid A and its assignment state in the case where the ISD measurement was performed under condition (d) (condition (d) in FIG. 6). In FIG. 7, a large number of fragment ions were detected, including the fragment ions within the low-mass region where no peak could be observed in FIG. 5 due to the low detection sensitivity. Approximately 60% of the base sequence could be determined. However, it was impossible to analyze the entire sequence since no fragment ion could be detected within a high-mass region near the precursor ion of standard nucleic acid A.

Ultimately, the entire sequence of the standard nucleic acid having a comparatively high mass (MW 6201) could be analyzed by combining the analysis result obtained from the mass spectrum data of FIG. 5 and the one obtained from the mass spectrum data of FIG. 7.

### Example 3

A mass spectrometric analysis and a structural analysis were performed in a similar manner to Example 1, except for a difference in the measurement conditions for the MS measurement and the ISD measurement.

### <4-1. MS Measurement>

The values in the following Table 5 were used as the conditions (various setting values of the mass spectrometer) for performing the MS measurement.

TABLE 5

| | Condition (a) |
|---|---|
| Measurement mode | mode 3 |
| | (m/z 2000-18000) |
| Detector voltage (DV-1) | 1700 |
| Conversion dynode voltage (DV-2) | 7000 |
| RFdelay (RF) | 25 |
| Laser power (LP) | 64 |
| Sample-stage voltage (SV) | 5 |
| Duty ratio | 50:50 |

### <4-2. ISD Measurement>

The values in the following Table 6 were used as the conditions (various setting values of the mass spectrometer) for performing the ISD measurement.

TABLE 6

| | Condition (b) | Condition (c) |
|---|---|---|
| Measurement mode | mode 3 | mode 3 |
| | (m/z 2000-18000) | (m/z 2000-18000) |
| Detector voltage (DV-1) | 2000 | 2000 |
| Conversion dynode voltage | 8000 | 8000 |
| (DV-2) | | |
| RFdelay (RF) | 17 | 17 |
| Laser power (LP) | 75 | 75 |
| Sample-stage voltage (SV) | 5 | 5 |
| Duty ratio | 50:50 | 52:48 |

### <Result>

Initially, though not shown, under condition (a), it was confirmed that the protonated molecule [M+H]⁺ of standard nucleic acid A could be detected with a high sensitivity.

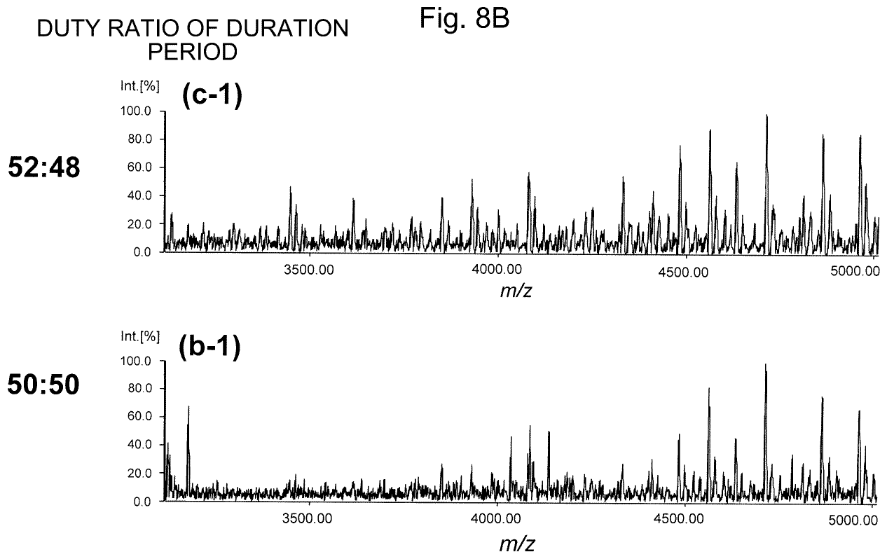

Next, FIGS. 8A and 8B show ISD spectra of standard nucleic acid A acquired by the ISD measurement under each condition (i.e., ISD spectra acquired using conditions (b) and (c), from the bottom). Of the ISD spectra under each condition, FIG. 8A shows the entire range of the mass-to-charge ratios covered by the measurement (m/z 2000-6000), while FIG. 8B is an enlarged view of a portion (m/z 3000-5000) of that range.

When the measurement was performed using condition (b) in which the detector voltage, conversion dynode voltage, RFdelay value and laser power were respectively changed from those of condition (a), the fragment ions within a high-mass region near the precursor ion were more easily detected ((b-2) in FIG. 8A). On the other hand, when the measurement was performed using condition (c) in which, in addition to the aforementioned changes, the duty ratio related to the radiofrequency voltage applied to the ion-capturing section was also changed so that the largest value of the mass-to-charge-ratio range of the ions to be captured within the ion trap would be smaller than the mass-to-charge ratio of the precursor ion, the fragment ions near the precursor ion were excluded ((c-2) in FIG. 8A), and the fragment ions within a low-mass region distant from the m/z value of the precursor ion were more easily detected ((c-2) in FIG. 8A and (c-1) in FIG. 8B). Consequently, due to the change in duty ratio, the peaks of the fragment ions within a low-mass region were detected with a higher level of intensity.

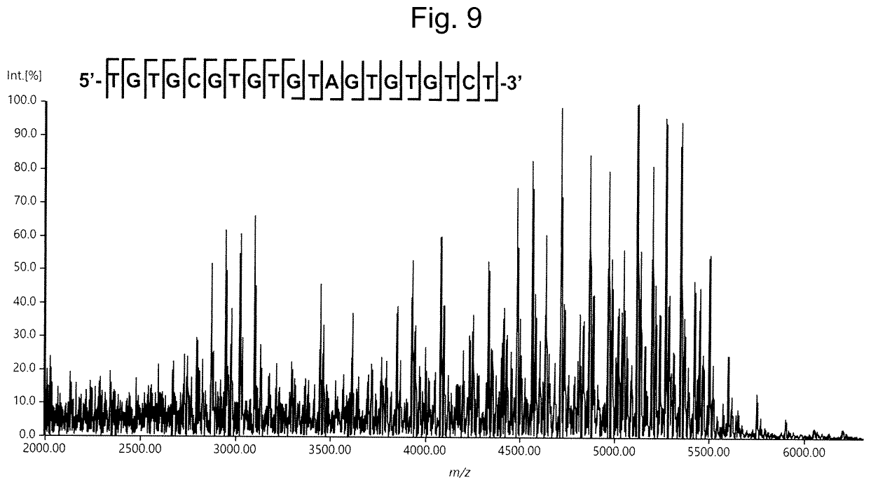

FIG. 9 shows the ISD spectrum of standard nucleic acid A as well as the sequence of standard nucleic acid A and its assignment state in the case where the ISD measurement was performed under condition (c). From FIG. 9, it was possible to determine the assignment of a large number of fragment ions, including ions having low peak intensities, and to analyze the entire sequence. However, under the present condition, the intensity of the fragment ions near the precursor ion was low.

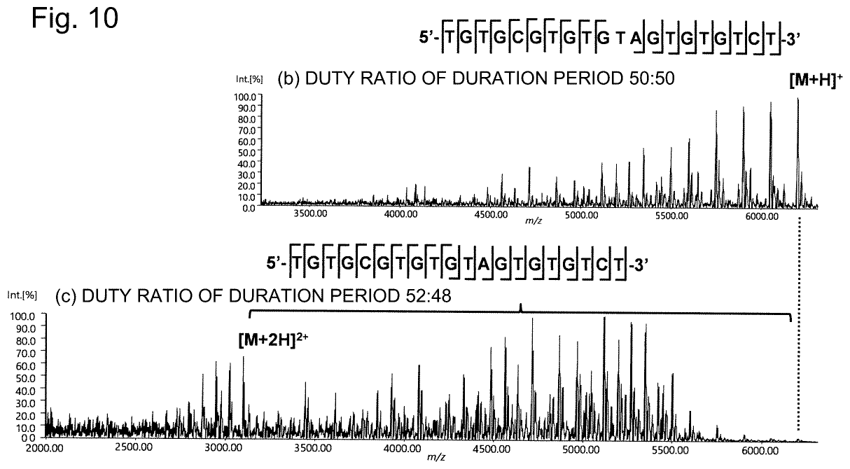

FIG. 10 shows the ISD spectra of standard nucleic acid A (the upper one was acquired under condition (b), and the lower one, under condition (c)) as well as the sequence of standard nucleic acid A and its assignment state in the case where the ISD measurement was performed under conditions (b) and (c). In the mass spectrum acquired using condition (c), although the entire sequence of the nucleic acid could be analyzed, the peak intensity of the ions near the precursor ion was low. On the other hand, in the mass spectrum acquired using condition (b), the fragment ions near the precursor were observed with sufficient intensities. By combining the analysis results obtained from the mass spectrum data of conditions (b) and (c), the entire sequence of the standard nucleic acid having a comparatively high mass (MW 6201) could be more assuredly analyzed.

### Example 4

### <1. Preparation of Sample Solution>

A 20-pmol/μL aqueous solution of mipomersen (5′-MG-MC-MC-MU-MC-dA-dG-dT-dC-dT-dG-dC-dT-dT-dC-MG-MC-MA-MC-MC-3′, where M represents 2′-O-(2-methoxyethyl) nucleoside and d represents 2′-deoxynucleoside; the C5 carbon of cytosine and uracil are replaced by the methyl group, while the phosphodiester bonds at all inter-nucleotide sections are replaced by the phosphorothioate bonds; Sequence Number 2) was prepared as a sample solution. (This sample was obtained through the desalting and purification of a synthetic nucleic acid for research and development; DNA: the entire length was 20 bases; MW 7177).

### <2. Preparation of Matrix Solution>

A 40 mg/mL-50% ACN aqueous solution of 3-hydroxypicolinic acid (3-HPA) containing 40 mM of ACD as a matrix additive (3-HPA solution), and a 40 mg/mL-50% ACN aqueous solution of 2,4-DHAP containing 70 mM of ACD as a matrix additive (2,4-DHAP solution) were prepared. A mixed matrix (3-HPA+2,4-DHAP, 1:1) solution consisting of a 1:1 (v/v) mixture of the 3-HPA solution and the 2,4-DHAP solution was prepared.

### <3. Preparation of Sample for Analysis>

The sample solution prepared in “1.” and the mixed matrix solution prepared in “2.” were mixed at 1:1 (v/v), and 1 μL of the obtained mixed solution was dropped onto a sample plate (stainless steel plate) and dried.

### <4. Mass Spectrometric Analysis>

### <4.1 ISD Measurement>

The sample plate in “3.” was set in a MALDI-DITMS (manufactured by Shimadzu Corporation, product name: MALDImini-1), and an ISD measurement was performed in the positive mode, using the raster function. The values in the following Table 7 were used as the conditions (various setting values of the mass spectrometer) for performing the ISD measurement. As regards the laser power, an optimum value under each condition was used.

TABLE 7

| | Condition (a) | Condition (b) |
|---|---|---|
| Measurement mode | mode 2 | mode 3 |
| | (m/z 650-5000) | (m/z 2000-18000) |
| Detector voltage (DV-1) | 2000 | 2000 |
| Conversion dynode voltage | 8000 | 8000 |
| (DV-2) | | |
| RFdelay (RF) | 17 | 17 |
| Laser power (LP) | 75 | 75 |
| Sample-stage voltage (SV) | 5 | 5 |
| Duty ratio | 50:50 | 50:50 |

### <4.2 MS/MS Measurement>

An MS/MS measurement (low-energy CID) was performed using a measurement condition in which a comparatively low-mass ISD fragment (this time, w5-ion) in the ISD spectrum acquired by the ISD measurement in “4-1.” was selected as the precursor ion.

### <5. Structural Analysis>

The assignment of principal fragment-ion peaks in the ISD spectrum acquired by the ISD measurement in “4-1.” and the MS/MS spectrum acquired by the MS/MS measurement in “4-2.” was determined, and the base sequence of mipomersen was analyzed.

### <Result>

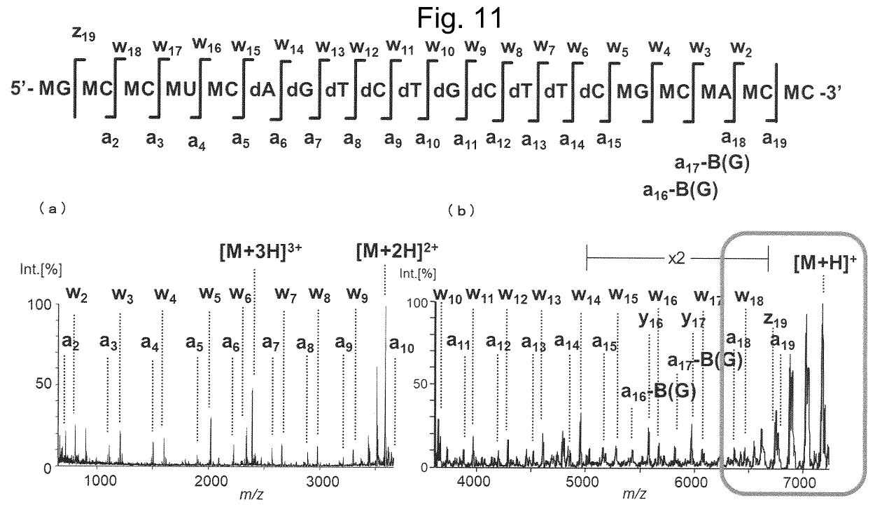

FIG. 11 shows the ISD spectra of mipomersen acquired by using the mixed matrix 3-HPA+2,4-DHAP as well as the assignment state of principal peaks. Diagram (a) in FIG. 11 is an ISD spectrum acquired by performing an ISD measurement using condition (a) in Table 7, while diagram (b) in FIG. 11 is an ISD spectrum acquired by performing an ISD measurement using condition (b) in Table 7. The bar labelled “x2” in diagram (b) in FIG. 11 indicates the section in which the peak-intensity scale is expanded to two times the scale in the other sections. Each peak in the ISD spectra in FIG. 11 has a label showing the name of the corresponding fragment ion species of the oligonucleotide (a general name proposed in Non Patent Literature 4). This name represents each ion species by a fragment ion series according to the dissociation pattern naming convention for nucleic acids, in which fragment ions including the 5′-ternimal are written as aₙ, bₙ, cₙ or dₙ, while fragment ions including the opposite 3′-terminal are written as xₘ, yₘ, zₘ Of wₘ. The subscripts n and m each represent the number of building blocks from the corresponding terminal to the dissociation site (by definition, the number of bases). The letter “B” in the name of the fragment ion species represents a base in the nucleic acid. For example, a₁₆-B (G) in diagram (b) in FIG. 11 indicates that it is an ion resulting from the elimination of the guanine base (G) from the a₁₆-ion. The same also applies in the following figure.

The portion surrounded by the frame at the right end of diagram (b) in FIG. 11 shows the spectrum near the m/z value of the molecular-related ion [M+H]⁺ (precursor ion). It was confirmed that, within this area, the base elimination peaks (or the likes) of the precursor ion are particularly detected with a high sensitivity, and the detection of ISD fragment peaks is impeded by those base elimination peaks (or the likes) overlapping with the ISD fragment peaks.

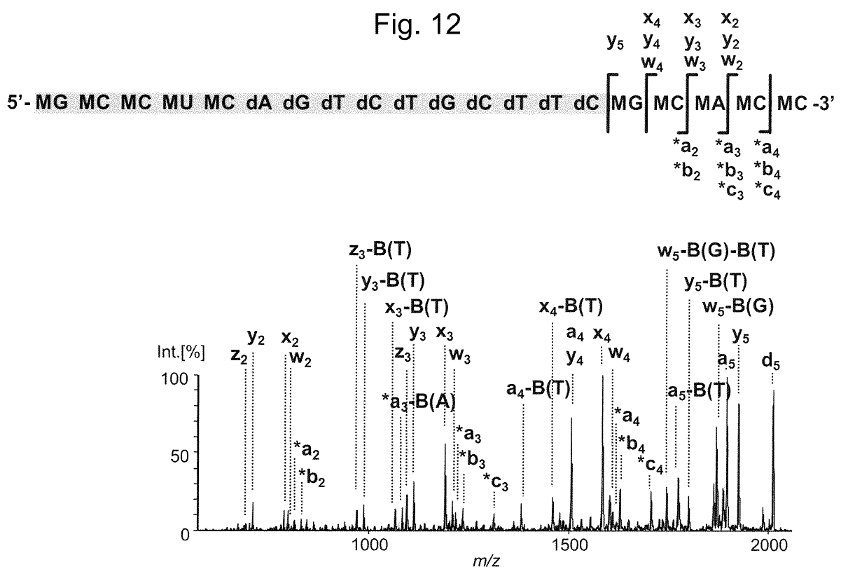

FIG. 12 shows an MS/MS spectrum for which the w₅-ion detected in the ISD spectra of FIG. 11 was used as the precursor ion, as well as the assignment state of principal peaks. As compared to the ISD spectra and the peak assignment state in FIG. 11, a plurality of kinds of second fragment ions including the terminal sequence information occurred with sufficient intensity and resolution in FIG. 12, so that the terminal sequence could be more assuredly analyzed. Furthermore, in the MS/MS spectrum of FIG. 12, no overlap was observed between the product-ion peaks near the precursor ion, such as the base elimination peaks as observed in the ISD spectrum in diagram (b) of FIG. 11, and the peaks of the second fragment ions.

In summary, after the largest possible amount of base sequence information was obtained from the ISD spectra in FIG. 11, an MS/MS measurement was performed in which an ISD fragment within a low-mass region comparatively distant from the m/z value of the molecular-related ion was selected as the precursor ion, whereby fragment-ion peaks which are located near the m/z value of the molecular-related ion, and whose peak detection is easily impeded in the ISD measurement, could be clearly detected, which allowed for an analysis of the base sequence of the terminals and thereby enabled the analysis of the entire base sequence with a higher degree of reliability. In other words, a more assured base sequence analysis was made possible by combining the ISD measurement and the MS/MS measurement.

The technique of combining the ISD measurement and the MS/MS measurement for performing a structural analysis in this manner can basically be used for any type of analysis target. It can also be improved so that the terminal sequence analysis, which is a challenging task in the ISD analysis by MALDI-MS, can be more assuredly performed. The present technique is particularly considered to be effective for nucleic acids which are unstable and easily undergo base elimination or similar cleavage, as well as in the case of performing a measurement using a MALDI-IT-TOFMS in which fragmentation easily occurs.

### [Modes]

It is evident to a person skilled in the art that the previously described illustrative embodiments are specific examples of the following modes.

### (Clause 1)

A method for a structural analysis of a sample molecule according to one mode of the present invention is a method for analyzing the structure of a sample molecule using an ion trap mass spectrometer including: an ion source employing a matrix-assisted laser desorption/ionization (MALDI) method; an ion-capturing section for separating, from ions generated in the ion source, an ion having a predetermined mass-to-charge ratio and capturing the same ion; and a detecting section for detecting an ion captured by the ion-capturing section, and the method including:
a standard analysis condition acquisition process for obtaining a standard analysis condition for each of setting items for performing a molecular-related ion measurement for detecting a molecular-related ion of the sample molecule contained in a sample by means of the mass spectrometer, where the setting items include an ion amount setting item concerning the amount of ions to be generated in the ion source, a mass-to-charge-ratio range setting item concerning the mass-to-charge-ratio range of ions to be captured in the ion-capturing section, and a signal intensity setting item concerning the signal intensity of an ion in the detecting section;
a product ion measurement data acquisition process for performing a product ion measurement for detecting a plurality kinds of first fragment ions resulting from dissociation of the molecular-related ion, under an altered analysis condition, to acquire mass spectrum data of the product ion measurement, where the altered analysis condition is prepared by changing at least one of the analysis conditions of the ion amount setting item, the mass-to-charge-ratio range setting item and the signal intensity setting item in the standard analysis condition obtained in the standard analysis condition acquisition process;
a first fragment peak extraction process for extracting peaks corresponding to the plurality of first fragment ions from the mass spectrum data acquired in the product ion measurement data acquisition process; and
a data analysis process for determining at least a portion of the structure of the sample molecule based on mass information of the peaks extracted in the first fragment peak extraction process.

By this method, fragment ions necessary for a structural analysis of a sample molecule can be detected with a high sensitivity over a comparatively wide mass range from low-mass to high-mass regions.

### (Clause 2)

The method for a structural analysis of a sample molecule according to Clause 1 may be a method in which:
the mass spectrometer is a device capable of an MS/MS measurement;
the method further includes:
   an MS/MS measurement condition setting process for setting a measurement condition for performing an MS/MS measurement in which at least one of the plurality kinds of first fragment ions detected in the product ion measurement is used as a precursor ion;
   an MS/MS measurement data acquisition process for performing the MS/MS measurement based on the measurement condition set in the MS/MS measurement condition setting process, to acquire mass spectrum data of the MS/MS measurement; and
   a second fragment peak extraction process for extracting, from the mass spectrum data acquired in the MS/MS measurement data acquisition process, a peak corresponding to a second fragment ion generated in the MS/MS measurement, and
the data analysis process includes determining at least a portion of the structure of the sample molecule based on mass information of the peaks extracted in the first fragment peak extraction process and mass information of the peak extracted in the second fragment peak extraction process.

By this method, not only the first fragment ions originating from the molecular-related ion but also the second fragment ion generated by further dissociating the first fragment ion can be detected with a high sensitivity. Consequently, for a sample molecule whose entire molecular structure cannot be accurately analyzed from only the mass information of the first fragment ions, the structural information can be more reliably determined based on the mass information of the first fragment ions and the second fragment ion.

### (Clause 3)

A method for a structural analysis of a sample molecule according to another mode of the present invention is a method for analyzing the structure of a sample molecule using an ion trap mass spectrometer including: an ion source employing a matrix-assisted laser desorption/ionization (MALDI) method; an ion-capturing section for separating, from ions generated in the ion source, an ion having a predetermined mass-to-charge ratio and capturing the same ion; and a detecting section for detecting an ion captured by the ion-capturing section, and the method including:
a standard analysis condition acquisition process for obtaining a standard analysis condition for each of setting items for performing a molecular-related ion measurement for detecting a molecular-related ion of the sample molecule contained in a sample by means of the mass spectrometer, where the setting items include an ion amount setting item concerning the amount of ions to be generated in the ion source, a mass-to-charge-ratio range setting item concerning the mass-to-charge-ratio range of ions to be captured in the ion-capturing section, and a signal intensity setting item concerning the signal intensity of an ion in the detecting section;
a product ion measurement process for performing a product ion measurement for detecting a plurality kind of first fragment ions resulting from dissociation of the molecular-related ion, under an altered analysis condition prepared by changing at least one of the analysis conditions of the ion amount setting item, the mass-to-charge-ratio range setting item and the signal intensity setting item in the standard analysis condition obtained in the standard analysis condition acquisition process;
an MS/MS measurement condition setting process for setting a measurement condition for performing an MS/MS measurement in which at least one of the plurality kinds of first fragment ions detected in the product ion measurement is used as a precursor ion;
an MS/MS measurement data acquisition process for acquiring mass spectrum data of the MS/MS measurement by performing the MS/MS measurement based on the measurement condition set in the MS/MS measurement condition setting process;
a second fragment peak extraction process for extracting, from the mass spectrum data acquired in the MS/MS measurement data acquisition process, a peak corresponding to a second fragment ion generated in the MS/MS measurement; and
a data analysis process for determining a portion of the structure of the sample molecule based on mass information of the peak extracted in the second fragment peak extraction process.

By this method, a second fragment ion generated by further dissociating a first fragment ion originating from a molecular-related ion can be detected with a high sensitivity. Consequently, structural information can be more assuredly determined for a partial molecular structure of a sample molecule which cannot be accurately analyzed based only on the mass information of the first fragment ions.

### (Clause 4)

The method for a structural analysis of a sample molecule according to one of Clauses 1-3 may be a method in which:
the altered analysis condition is a condition in which the analysis condition of the ion amount setting item is changed so that a larger amount of ions is generated in the ion source, or the analysis condition of the mass-to-charge-ratio range setting item is changed so that an ion within a lower mass region than the mass-to-charge ratio of the molecular-related ion of the sample molecule is captured in a prioritized manner, or the analysis condition of the signal intensity setting item is changed so that the signal intensity of an ion in the detecting section becomes higher, than when the molecular-related ion measurement of the sample molecule was performed under the standard analysis condition.

By this method, fragment ions at lower mass-to-charge ratios can be particularly detected with a high sensitivity among the fragment ions necessary for a data analysis.

### (Clause 5)

The method for a structural analysis of a sample molecule according to one of Clauses 1-4 may be a method in which:
the altered analysis condition is a condition in which the analysis condition of the ion amount setting item is changed so that the amount of ion to be generated in the ion source increases, and in which the analysis condition of the signal intensity setting item is changed so that the signal intensity of an ion in the detecting section becomes higher.

By this method, fragment ions at lower mass-to-charge ratios can be particularly detected with a higher sensitivity among the fragment ions necessary for a data analysis.

### (Clause 6)

The method for a structural analysis of a sample molecule according to one of Clauses 1-5 may be a method in which:
the ion amount setting item is a laser strength for irradiation in the ion source; and
the altered analysis condition is a condition in which the laser strength is changed to a larger value than the standard analysis condition.

By this method, fragment ions at lower mass-to-charge ratios can be particularly detected with a higher sensitivity among the fragment ions necessary for a data analysis.

### (Clause 7)

The method for a structural analysis of a sample molecule according to one of Clauses 1-6 may be a method in which:
the mass-to-charge-ratio range setting item is the period of time from the irradiation with laser in the ion source to the application of a capturing voltage for capturing ions in the ion-capturing section; and
the altered analysis condition is a condition in which the aforementioned period of time is changed to a shorter value than the standard analysis condition.

By this method, fragment ions at lower mass-to-charge ratios can be particularly detected with a higher sensitivity among the fragment ions necessary for a data analysis.

### (Clause 8)

The method for a structural analysis of a sample molecule according to Clause 7 may be a method in which:
the altered analysis condition is a condition in which the aforementioned period of time is set to be a value which is 1-3 microseconds shorter than the standard analysis condition.

By this method, fragment ions at lower mass-to-charge ratios can be particularly detected with an even higher sensitivity among the fragment ions necessary for a data analysis.

### (Clause 9)

The method for a structural analysis of a sample molecule according to one of Clauses 1-8 may be a method in which:
the detecting section includes a conversion dynode and a detector;
the signal intensity setting item is an application voltage to the conversion dynode and an application voltage to the detector; and
the altered analysis condition is a condition in which at least one of the application voltages to the conversion dynode and the detector is changed to a larger value than the standard analysis condition.

By this method, fragment ions at lower mass-to-charge ratios can be particularly detected with a higher sensitivity among the fragment ions necessary for a data analysis.

### (Clause 10)

The method for a structural analysis of a sample molecule according to one of Clauses 1-9 may be a method in which:
the product ion measurement is performed under a condition in which the range of the predetermined mass-to-charge ratios of the ions to be captured in the ion-capturing section is set so that the largest value of the predetermined mass-to-charge ratios becomes smaller than the value of the mass-to-charge ratio of the molecular-related ion of the sample molecule.

By this method, fragment ions at lower mass-to-charge ratios can be particularly detected with a higher sensitivity among the fragment ions necessary for a data analysis.

### (Clause 11)

The method for a structural analysis of a sample molecule according to Clause 10 may be a method in which:
the range of the predetermined mass-to-charge ratios is set through the setting of the frequency of a capturing voltage for capturing ions in the ion-capturing section.

By this method, fragment ions at lower mass-to-charge ratios can be particularly detected with a higher sensitivity among the fragment ions necessary for a data analysis.

### (Clause 12)

The method for a structural analysis of a sample molecule according to Clause 10 may be a method in which:
the mass spectrometer is a digital ion trap mass spectrometer; and
the range of the predetermined mass-to-charge ratios is set through the setting of the duty ratio of a capturing voltage for capturing ions in the ion-capturing section.

By this method, fragment ions at lower mass-to-charge ratios can be particularly detected with a higher sensitivity among the fragment ions necessary for a data analysis.

### (Clause 13)

The method for a structural analysis of a sample molecule according to one of Clauses 10-12 may be a method in which:
the mass spectrometer includes a sample stage on which a sample plate, with a sample placed thereon, is to be placed;
the standard analysis condition acquisition process further includes acquiring a standard analysis condition of an application voltage to the sample stage for the molecular-related ion measurement; and
the product ion measurement is performed under a condition in which the application voltage to the sample stage is changed to a larger value than the standard analysis condition.

By this method, fragment ions at lower mass-to-charge ratios can be particularly detected with an even higher sensitivity among the fragment ions necessary for a data analysis.

### (Clause 14)

The method for a structural analysis of a sample molecule according to one of Clauses 1, 2 and 4-13 may be a method in which:
the mass spectrometer is a digital ion trap mass spectrometer;
the product ion measurement data acquisition process further includes performing the product ion measurement under a condition in which at least the frequency of a capturing voltage for capturing ions or the duty ratio of the capturing voltage in the ion-capturing section is changed so that the largest value of the predetermined mass-to-charge ratios of the ions to be captured in the ion-capturing section becomes smaller than the value of the mass-to-charge ratio of the molecular-related ion of the sample molecule, as well as under a condition in which neither the frequency of the capturing voltage nor the duty ratio of the capturing voltage is changed, so as to acquire mass spectrum data of the product ion measurement under each condition;
the first fragment peak extraction process includes extracting peaks corresponding to the plurality of first fragment ions in both the mass spectrum data acquired in the product ion measurement data acquisition process by performing the product ion measurement under the condition in which at least the frequency of the capturing voltage or the duty ratio of the capturing voltage is changed, and the mass spectrum data acquired in the product ion measurement data acquisition process by performing the product ion measurement under the condition in which neither the frequency of the capturing voltage nor the duty ratio of the capturing voltage is changed; and
the data analysis process includes determining at least a portion of the structure of the sample molecule based on mass information of the peaks extracted in the first fragment peak extraction process.

By this method, the structure of the sample molecule can be more assuredly analyzed.

### (Clause 15)

In the method for a structural analysis of a sample molecule according to one of Clauses 1-14, the sample molecule may be a nucleic acid or a nucleic-acid-related substance.

### (Clause 16)

In the method for a structural analysis of a sample molecule according to Clause 2, the sample molecule may be a nucleic acid or a nucleic-acid-related substance, and the aforementioned portion of the structure of the sample molecule may be the structure of a terminal portion of the nucleic acid or the nucleic-acid-related substance.

### (Clause 17)

In the method for a structural analysis of a sample molecule according to Clause 3, the sample molecule may be a nucleic acid or a nucleic-acid-related substance, and the aforementioned portion of the structure of the sample molecule may be the structure of a terminal portion of the nucleic acid or the nucleic-acid-related substance.

### REFERENCE SIGNS LIST

1 . . . Ion Source
2 . . . Ion Trap
3 . . . Detecting Section
11 . . . Laser Irradiator
12 . . . Sample Stage
21 Ring Electrode
22, 23 . . . End-Cap Electrode
31 . . . Conversion Dynode
32 . . . Detector (Secondary Electron Multiplier Tube)

### SEQUENCE LISTING

1. A method for a structural analysis of a sample molecule using an ion trap mass spectrometer including: an ion source employing a matrix-assisted laser desorption/ionization (MALDI) method; an ion-capturing section for separating, from ions generated in the ion source, an ion having a predetermined mass-to-charge ratio and capturing the same ion; and a detecting section for detecting an ion captured by the ion-capturing section, the method comprising:
a standard analysis condition acquisition process for obtaining a standard analysis condition for each of setting items for performing a molecular-related ion measurement for detecting a molecular-related ion of the sample molecule contained in a sample by means of the mass spectrometer, where the setting items include an ion amount setting item concerning an amount of ions to be generated in the ion source, a mass-to-charge-ratio range setting item concerning a mass-to-charge-ratio range of ions to be captured in the ion-capturing section, and a signal intensity setting item concerning a signal intensity of an ion in the detecting section;
a product ion measurement data acquisition process for performing a product ion measurement for detecting a plurality kinds of first fragment ions resulting from dissociation of the molecular-related ion, under an altered analysis condition, to acquire mass spectrum data of the product ion measurement, where the altered analysis condition is prepared by changing at least one of analysis conditions of the ion amount setting item, the mass-to-charge-ratio range setting item and the signal intensity setting item in the standard analysis condition obtained in the standard analysis condition acquisition process;
a first fragment peak extraction process for extracting peaks corresponding to the plurality kinds of first fragment ions from the mass spectrum data acquired in the product ion measurement data acquisition process; and
a data analysis process for determining at least a portion of the structure of the sample molecule based on mass information of the peaks extracted in the first fragment peak extraction process.

2. The method for a structural analysis of a sample molecule according to claim 1, wherein:
the mass spectrometer is a device capable of an MS/MS measurement;
the method further includes:
an MS/MS measurement condition setting process for setting a measurement condition for performing an MS/MS measurement in which at least one of the plurality kinds of first fragment ions detected in the product ion measurement is used as a precursor ion;
an MS/MS measurement data acquisition process for performing the MS/MS measurement based on the measurement condition set in the MS/MS measurement condition setting process, to acquire mass spectrum data of the MS/MS measurement; and
a second fragment peak extraction process for extracting, from the mass spectrum data acquired in the MS/MS measurement data acquisition process, a peak corresponding to a second fragment ion generated in the MS/MS measurement, and
the data analysis process includes determining at least a portion of the structure of the sample molecule based on mass information of the peaks extracted in the first fragment peak extraction process and mass information of the peak extracted in the second fragment peak extraction process.

3. A method for a structural analysis of a sample molecule using an ion trap mass spectrometer including: an ion source employing a matrix-assisted laser desorption/ionization (MALDI) method; an ion-capturing section for separating, from ions generated in the ion source, an ion having a predetermined mass-to-charge ratio and capturing the same ion; and a detecting section for detecting an ion captured by the ion-capturing section, the method comprising:
a standard analysis condition acquisition process for obtaining a standard analysis condition for each of setting items for performing a molecular-related ion measurement for detecting a molecular-related ion of the sample molecule contained in a sample by means of the mass spectrometer, where the setting items include an ion amount setting item concerning an amount of ions to be generated in the ion source, a mass-to-charge-ratio range setting item concerning a mass-to-charge-ratio range of ions to be captured in the ion-capturing section, and a signal intensity setting item concerning a signal intensity of an ion in the detecting section;
a product ion measurement process for performing a product ion measurement for detecting a plurality kind of first fragment ions resulting from dissociation of the molecular-related ion, under an altered analysis condition prepared by changing at least one of analysis conditions of the ion amount setting item, the mass-to-charge-ratio range setting item and the signal intensity setting item in the standard analysis condition obtained in the standard analysis condition acquisition process;
an MS/MS measurement condition setting process for setting a measurement condition for performing an MS/MS measurement in which at least one of the plurality kinds of first fragment ions detected in the product ion measurement is used as a precursor ion;
an MS/MS measurement data acquisition process for acquiring mass spectrum data of the MS/MS measurement by performing the MS/MS measurement based on the measurement condition set in the MS/MS measurement condition setting process;
a second fragment peak extraction process for extracting, from the mass spectrum data acquired in the MS/MS measurement data acquisition process, a peak corresponding to a second fragment ion generated in the MS/MS measurement; and
a data analysis process for determining a portion of the structure of the sample molecule based on mass information of the peak extracted in the second fragment peak extraction process.

4. The method for a structural analysis of a sample molecule according to claim 1, wherein the altered analysis condition is a condition in which the analysis condition of the ion amount setting item is changed so that a larger amount of ions is generated in the ion source, or the analysis condition of the mass-to-charge-ratio range setting item is changed so that an ion within a lower mass region than a mass-to-charge ratio of the molecular-related ion of the sample molecule is captured in a prioritized manner, or the analysis condition of the signal intensity setting item is changed so that the signal intensity of an ion in the detecting section becomes higher, than when the molecular-related ion measurement of the sample molecule was performed under the standard analysis condition.

5. The method for a structural analysis of a sample molecule according to claim 1, wherein the altered analysis condition is a condition in which the analysis condition of the ion amount setting item is changed so that the amount of ion to be generated in the ion source increases, and in which the analysis condition of the signal intensity setting item is changed so that the signal intensity of an ion in the detecting section becomes higher.

6. The method for a structural analysis of a sample molecule according to claim 1, wherein:
the ion amount setting item is a laser strength for irradiation in the ion source; and
the altered analysis condition is a condition in which the laser strength is changed to a larger value than the standard analysis condition.

7. The method for a structural analysis of a sample molecule according to claim 1, wherein:
the mass-to-charge-ratio range setting item is a period of time from an irradiation with laser in the ion source to an application of a capturing voltage for capturing ions in the ion-capturing section; and
the altered analysis condition is a condition in which the aforementioned period of time is changed to a shorter value than the standard analysis condition.

8. The method for a structural analysis of a sample molecule according to claim 7, wherein the altered analysis condition is a condition in which the aforementioned period of time is set to be a value which is 1-3 microseconds shorter than the standard analysis condition.

9. The method for a structural analysis of a sample molecule according to claim 1, wherein:
the detecting section includes a conversion dynode and a detector;
the signal intensity setting item is an application voltage to the conversion dynode and an application voltage to the detector; and
the altered analysis condition is a condition in which at least one of the application voltages to the conversion dynode and the detector is changed to a larger value than the standard analysis condition.

10. The method for a structural analysis of a sample molecule according to claim 1, wherein the product ion measurement is performed under a condition in which a range of the predetermined mass-to-charge ratios of the ions to be captured in the ion-capturing section is set so that a largest value of the predetermined mass-to-charge ratios becomes smaller than a value of the mass-to-charge ratio of the molecular-related ion of the sample molecule.

11. The method for a structural analysis of a sample molecule according to claim 10, wherein the range of the predetermined mass-to-charge ratios is set through a setting of a frequency of a capturing voltage for capturing ions in the ion-capturing section.

12. The method for a structural analysis of a sample molecule according to claim 10, wherein:
the mass spectrometer is a digital ion trap mass spectrometer; and
the range of the predetermined mass-to-charge ratios is set through a setting of the duty ratio of a capturing voltage for capturing ions in the ion-capturing section.

13. The method for a structural analysis of a sample molecule according to claim 10, wherein:
the mass spectrometer includes a sample stage on which a sample plate, with a sample placed thereon, is to be placed;
the standard analysis condition acquisition process further includes acquiring a standard analysis condition of an application voltage to the sample stage for the molecular-related ion measurement; and
the product ion measurement is performed under a condition in which the application voltage to the sample stage is changed to a larger value than the standard analysis condition.

14. The method for a structural analysis of a sample molecule according to claim 1, wherein:
the mass spectrometer is a digital ion trap mass spectrometer;
the product ion measurement data acquisition process further includes performing the product ion measurement under a condition in which at least a frequency of a capturing voltage for capturing ions or a duty ratio of the capturing voltage in the ion-capturing section is changed so that a largest value of the predetermined mass-to-charge ratios of the ions to be captured in the ion-capturing section becomes smaller than a value of the mass-to-charge ratio of the molecular-related ion of the sample molecule, as well as under a condition in which neither the frequency of the capturing voltage nor the duty ratio of the capturing voltage is changed, so as to acquire mass spectrum data of the product ion measurement under each condition;
the first fragment peak extraction process includes extracting peaks corresponding to the plurality of first fragment ions in both the mass spectrum data acquired in the product ion measurement data acquisition process by performing the product ion measurement under the condition in which at least the frequency of the capturing voltage or the duty ratio of the capturing voltage is changed, and the mass spectrum data acquired in the product ion measurement data acquisition process by performing the product ion measurement under the condition in which neither the frequency of the capturing voltage nor the duty ratio of the capturing voltage is changed; and
the data analysis process includes determining at least a portion of the structure of the sample molecule based on mass information of the peaks extracted in the first fragment peak extraction process.

15. The method for a structural analysis of a sample molecule according to claim 1, wherein the sample molecule is a nucleic acid or a nucleic-acid-related substance.

16. The method for a structural analysis of a sample molecule according to claim 2, wherein the sample molecule is a nucleic acid or a nucleic-acid-related substance, and the aforementioned portion of the structure of the sample molecule is the structure of a terminal portion of the nucleic acid or the nucleic-acid-related substance.

17. The method for a structural analysis of a sample molecule according to claim 3, wherein the sample molecule is a nucleic acid or a nucleic-acid-related substance, and the aforementioned portion of the structure of the sample molecule is the structure of a terminal portion of the nucleic acid or the nucleic-acid-related substance.


SEQUENCE LISTING (2 sequences)

SEQ ID NO: 1 - DNA, 20 bp, synthetic construct
  source 1..20: mol_type = other DNA
tgtgcgtgtgtagtgtgtct

SEQ ID NO: 2 - DNA, 20 bp, synthetic construct
  source 1..20: mol_type = other DNA
  modified_base 1: mod_base = OTHER; note = 2'-O-(2-methoxyethyl)-guanosine-3'-monothiophosphat e
  modified_base 2..3: mod_base = OTHER; note = 2'-O-(2-methoxyethyl)-5-methyl-cytidine-3'-monothio phosphate
  modified_base 4: mod_base = OTHER; note = 2'-O-(2-methoxyethyl)-5-methyl-uridine-3'-monothiop hosphate
  modified_base 5: mod_base = OTHER; note = 2'-O-(2-methoxyethyl)-5-methyl-cytidine-3'-monothio phosphate
  modified_base 6: mod_base = OTHER; note = 2'-deoxy-adenosine-3'-monothiophosphate
  modified_base 7: mod_base = OTHER; note = 2'-deoxy-guanosine-3'-monothiophosphate
  modified_base 8: mod_base = OTHER; note = thymidine-3'-monothiophosphate
  modified_base 9: mod_base = OTHER; note = 2'-deoxy-5-methyl-cytidine-3'-monothiophosphate
  modified_base 10: mod_base = OTHER; note = thymidine-3'-monothiophosphate
  modified_base 11: mod_base = OTHER; note = 2'-deoxy-guanosine-3'-monothiophosphate
  modified_base 12: mod_base = OTHER; note = 2'-deoxy-5-methyl-cytidine-3'-monothiophosphate
  modified_base 13..14: mod_base = OTHER; note = thymidine-3'-monothiophosphate
  modified_base 15: mod_base = OTHER; note = 2'-deoxy-5-methyl-cytidine-3'-monothiophosphate
  modified_base 16: mod_base = OTHER; note = 2'-O-(2-methoxyethyl)-guanosine-3'-monothiophosphat e
  modified_base 17: mod_base = OTHER; note = 2'-O-(2-methoxyethyl)-5-methyl-cytidine-3'-monothio phosphate
  modified_base 18: mod_base = OTHER; note = 2'-O-(2-methoxyethyl)-adenosine-3'-monothiophosphat e
  modified_base 19..20: mod_base = OTHER; note = 2'-O-(2-methoxyethyl)-5-methyl-cytidine-3'-monothio phosphate
gcctcagtctgcttcgcacc